(19) United States
(12) Patent Application Publication
(10) Pub. No.: US 2015/0328794 A1
(43) Pub. Date: Nov. 19, 2015

(54) METHOD OF AUTOMATIC TOOL IDENTIFICATION AND TOOL IDENTIFIED

(71) Applicant: Peter ONDRUS, (US)

(72) Inventors: Peter Ondrus, Zilina (SK); Juraj Sebo, Kosice (SK)

(21) Appl. No.: 14/440,741

(22) PCT Filed: Nov. 5, 2013
(86) PCT No.: PCT/SK2013/050011

§ 371 Date: May 5, 2015

(30) Foreign Application Priority Data
Nov. 5, 2012 (SK) PP50050-2012

(51) Int. Cl. B26D 5/00; B26F 1/40; C14B 5/00; H04N 5/225

(52) U.S. Cl. CPC B26D 5/007; H04N 5/225; B26F 1/40; C14B 5/00

(57) ABSTRACT

A graphical code (2) scanner (4) is placed above the handling workbench in front of the press machine or above every workbench (3).The scanner is controlled by computer (5) software. The tools (1) are put on the surface of the entire hide or fabric, a mechanical press is applied and several different pieces are stamped out simultaneously. Having placed all the tools (1), the operator activates the software controlling the scanner (4) at the moment when the workbench with the hide and tools (1) is located just under the scanner (4). The scanner (4) reads the graphical codes (2) and the cutting process continues as the press exerts pressure upon the tools (1), cutting out pieces of leather or fabric depending on the shape of the tools (1). In parallel with the process of stamping, the software identifies the graphical codes (2) on the tools (1) and processes them. The tool (1)—a die—features a blade (10) with a cutting edge at the bottom. The blade (10) has the desired shape and is reinforced with reinforcements (11). The tool comprises also a graphical code (2). This graphical code (2) can be located either on the reinforcement (11) or on the blade (10).

### TECHNICAL FIELD

The invention concerns a method of automatic identification of tools and the identified tool used primarily in the leather and textile industries. Manufactured parts are subsequently processed in the automotive and furniture industries as upholstery covers.

### PRIOR ART

The leather and textile industry currently uses a number of different technologies for cutting leather or fabric to desired shapes. Cutting by carving plotters is one of them. In this case, pre-defined pieces are cut using software. The program needs to be adjusted for hides with non-homogenous dimensions to avoid unnecessarily high waste.

Another method is stamping the pieces out by iron tools—stampers which have blades in the shape that needs to be cut. In large-scale production, required in the furniture or automotive industries, such tools are put on the surface of the entire hide or fabric, a mechanical press is applied and several different pieces are stamped out simultaneously. There may be about 8 workbenches around one press machine and entire hides or large pieces of fabric are handled on each of these workbenches. The most important criterion for placing the cutting dies on the hide is the use of material. Thus, it is not so important to cut out parts exactly as requested. What is important is to ensure that the waste is as minimal as possible. The operator therefore aims to fit all the cutting dies on the hide and only then enters the number of cutting dies being used into the computer.

### NATURE OF THE INVENTION

The essence of the invention presented in this technical design is in the proposed method of automatic identification of tools that can automatically identify all the dies that are being used and in the designed tool—a die suitable for use with this method. Every tool (a die) is marked with a label bearing a graphical code containing a graphically encoded identification number of the die type. This code must be small enough to fit even small-sized dies, but the characters of the code should be large enough to be recognised at once from a single snapshot of the entire workbench, i.e. approximately 3200×3200 mm. The graphical code should be used to label about 10,000 different tools. The graphical code is a code where the minimum thickness of lines and squares is distinguishable when surface areas of at least 2000×2000 mm or more are scanned. Bar codes or QR codes can be used for smaller surface areas.

A code scanner, controlled by software on a computer, is placed above the handling workbench in front of the press or above every workbench. The tools are put on the surface of the entire hide or fabric, a mechanical press is applied and several different pieces are stamped out simultaneously. There may be about 8 workbenches around one press machine and entire hides or large pieces of fabric are handled on each of these workbenches. The most important criterion for placing the cutting dies on the hide is the use of material. Having placed all the dies, the operator activates the software controlling the scanner at the moment when the workbench with the hide and dies is located just under the scanner. The scanner reads the codes and the cutting process continues as the press exerts pressure upon the tools, cutting out pieces of leather or fabric depending on the shape of the tools. In parallel with the process of stamping, the software identifies the codes on the tools and processes them.

A camera can be used as the scanner. Once activated, it will make a snapshot in high-resolution for perfect identification of the graphical codes. In parallel with the stamping process, the software will load the high-resolution snapshot into a computer, where the snapshot is analysed and the graphical codes on the tools are recognised and processed further.

The tool—a die—features a blade with a cutting edge at the bottom. The blade has the desired shape and is reinforced with reinforcements. The tool comprises also a graphical code. This graphical code can be located either on the reinforcement or on the blade.

### SUMMARY OF DRAWINGS

FIG. 1 shows an example of a tool with a graphical code.

FIG. 2 shows a workbench with a graphical code scanner or a camera fitted above the workbench.

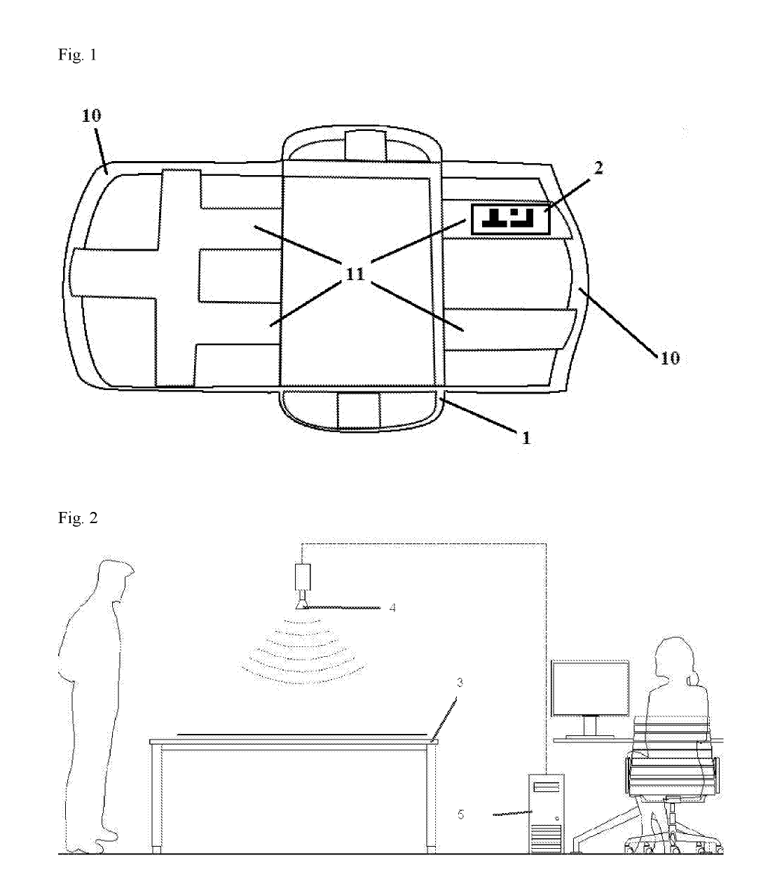

### EXAMPLES OF CARRYING OUT OF THE INVENTION

The proposed method of automatic identification of tools 1 that can automatically identify all the tools 1 that are being used, including the designed tool 1, which is a die suitable for use with this method. Every tool 1 (a die) is marked either with a graphical code 2 or a label showing the graphical code 2 containing a graphically encoded identification number of the tool type 1. This graphical code 2 must be small enough to fit even small-sized tools 1, but the characters of the code should be large enough to be recognised at once from a single snapshot of the entire workbench 3, i.e. approximately 3200×3200 mm. The graphical code 2 is used to label about 10,000 different tools 1. The graphical code 2 is a code where the minimum thickness of lines and squares is distinguishable when surface areas of at least 2000×2000 mm or more are scanned. Bar codes or QR codes can be used for smaller surface areas.

A graphical code 2 scanner 4, controlled by software on a computer 5, is placed above the handling workbench in front of the press or above every workbench 3. The tools 1 are put on the surface of the entire hide or fabric, a mechanical press is applied and several different pieces are stamped out simultaneously. There may be up to eight workbenches 3 around one press machine and entire hides or large pieces of fabric are handled on each of these workbenches 3. The most important criterion for placing the tools 1 on the hide is the use of material. Having placed all the tools 1, the operator activates the software controlling the scanner at the moment when the workbench with the hide and the tools 1 is located just under the scanner 4. The scanner 4 reads the graphical codes 2 and the cutting process continues as the press exerts pressure upon the tools 1, cutting out pieces of leather or fabric depending on the shape of the tools 1. In parallel with the process of stamping, the software identifies the graphical codes 2 on the tools 1 and processes them.

A camera can be used as the scanner 4. Once activated, it will make a snapshot in high-resolution for perfect identification of the graphical codes 2. In parallel with the stamping process, the software will load the high-resolution snapshot into a computer 5, where the snapshot is analysed and the graphical codes 2 on the tools 1 are recognised and processed further.

The tool 1 a die features a blade 10 with a cutting edge at the bottom. The blade 10 has the desired shape and is reinforced with reinforcements 11. The tool comprises also a graphical code 2. This graphical code 2 can be located either on the reinforcement 11 or on the blade 10.

1.-4. (canceled)

5. A method of optical identification of hide or fabric cutting tools employing a computer controlled graphical code scanner, comprising the steps of:
(1) providing a plurality of hide or fabric cutting tools each having a graphical code identifying indicia corresponding to the tool type;
(2) placing the hide or fabric on a work surface;
(3) placing the plurality of cutting tools on the hide or fabric;
(4) activating the graphical code scanner to optically read the graphical codes on the hide or fabric before cutting the hide or fabric with the cutting tools; and
(5) cutting out pieces of hide or fabric depending on the shape of the cutting tools.

6. The method of claim 5, wherein the graphical code scanner is a camera and the activating step includes taking a photograph of the cutting tools on the hide or fabric having sufficiently high resolution to optically identify all of the graphical codes associated with the cutting tools on the hide or fabric.

7. The method of claim 6, wherein the minimum thickness of the indicia on the graphical codes is optically distinguishable when surface area scanned is at least 2000×2000 mm.

8. The method of claim 6, wherein when the surface area scanned is a less than 2000×2000 mm the graphical code is a bar code or QR code.

9. The method of claim 6, wherein each of the plurality of cutting tools have:
a blade at the bottom in the form of the desired shaped to be cut; and
a reinforcement, and the graphical code is located either on the blade or the reinforcement.
